(19) United States
(12) Patent Application Publication
(10) Pub. No.: US 2024/0255140 A1
(43) Pub. Date: Aug. 1, 2024

(54) DARK RADIATOR

(71) Applicant: Schwank GmbH, Koeln (DE)

(72) Inventors: Edgar KREIS, Freigericht (DE); Alexander GENZEL, Bonn (DE); Torsten STOHLER, Mettmann (DE); Thomas RENNER, Wesseling (DE)

(73) Assignee: Schwank GmbH, Koeln (DE)

(21) Appl. No.: 18/564,151

(22) PCT Filed: Dec. 6, 2022
(86) PCT No.: PCT/EP2022/084655

§ 371 Date: Nov. 27, 2023

(30) Foreign Application Priority Data
Dec. 10, 2021 (EP) 21213748.3

(51) Int. Cl. F23D 14/12; F23C 9/00; F23N 1/02

(52) U.S. Cl. CPC F23D 14/12; F23C 9/00; F23N 1/022; F23C 2202/30; F23C 2900/03009; F23C 2900/9901; F23D 2203/005; F23N 2229/04

(57) ABSTRACT

A dark radiator includes a burner, a fan and a radiant tube, wherein the burner is connected to a fuel gas supply, wherein the fan is designed to supply the burner with combustion air, wherein the burner is designed to output a flame into the radiant tube, wherein the fuel gas supply is connected to a hydrogen source as a fuel gas source and has a gas nozzle, and wherein an ignition device is arranged spaced apart from the gas nozzle, without the existence of a flame holder.

The invention relates to a dark radiator, having a burner, a fan, and a radiant tube, wherein the burner is connected to a fuel gas supply, wherein the fan is set up for supplying combustion air to the burner, wherein the burner is set up for outputting a flame into the radiant tube.

In the commercial and industrial sector, dark radiators are frequently used for heating production and warehousing sites. Dark radiators have one or more radiant tubes as radiating elements, to which at least one burner is assigned. By means of combustion of a mixture of fuel gas and air within the burner, a flame is generated, which can be distributed over the entire length of the radiant tube, using a fan. The radiant tubes are regularly connected to be continuous and linear or U-shaped subsequent to the burner, and are supposed to emit the heat generated by the flame uniformly over the entire tube progression. The radiant tube is uniformly heated by the flame and generates a heat radiation that is emitted to a region to be heated. To increase the degree of effectiveness, reflectors are frequently used in this regard. The exhaust gases that result from combustion are removed from the radiant tube using the fan, for example they are conducted away to the outside air by way of exhaust gas tubes.

Natural gas or liquefied gas (propane gas or biogas) serves as the fuel gas, which is mixed with combustion air in a predetermined ratio in a mixing chamber and afterward conducted into the combustion chamber by means of a burner plate provided with passage channels, and ignited. The burner plate, which is regularly configured as a ceramic plate, serves as a flashback barrier and simultaneously has the task of holding the flame. Alternatively, grids or meshes are also used as a flashback barrier and a flame holder, through which the fuel/air mixture is passed. Such a dark radiator is described, for example, in EP 2 014 980 A1 and EP 2 708 814 A1.

The burners of the previously known dark radiators are increasingly becoming more complicated. This is true, last but not least, against the background of the constant striving to achieve an optimal stoichiometric ratio between fuel gas and air, so as to achieve the most complete combustion possible, so as to minimize the emission of harmful substances.

This is where the invention takes its start. The invention is based on the task of making available a dark radiator that has a simple structure and can be produced in a cost-advantageous manner. According to the invention, this task is accomplished by means of the characteristics of the characterizing part of claim 1.

With the invention, a dark radiator is made available that has a simple structure and can be produced in a cost-advantageous manner. Because of the fact that the fuel gas supply is connected to a hydrogen source as the fuel gas source and has a gas nozzle, wherein an ignition device is arranged at a distance from the gas nozzle, without the presence of a flame holder, a simple structure having a reduced number of components is achieved. Surprisingly, it has been shown that by using hydrogen as the fuel gas, premixing with combustion air is not required. Because of the fact that the stream of hydrogen, which exits from the nozzle under pressure, ignites after contact with the combustion air situated in front of the nozzle, due to its reactivity, when the required mixture ratio has been reached, a stable flame forms at a sufficient distance from the nozzle, which flame maintains itself without the risk of flame flashback into the nozzle. The flame holder used in the state of the art, which simultaneously has the function of flashback prevention there, is not required. In addition, reduced emission of harmful substances is achieved. Since hydrogen does not contain any carbon, theoretically no harmful substances containing carbon, such as carbon monoxide, carbon dioxide or hydrocarbons, are contained in the exhaust gas.

In a further development of the invention, the fan is arranged in such a manner that the radiant tube is flooded with combustion air, at least in the flame direction, behind the gas nozzle. In this way, a sufficient supply of combustion air to the region in front of the nozzle is guaranteed, which air supports mixing with the hydrogen exiting from the nozzle with its flow. Preferably the fan is arranged in such a manner that the gas nozzle is flushed with combustion air.

In an embodiment of the invention, the fan is connected, on the suction side, to an exhaust gas line that is connected to the radiant tube. In this way, recirculation of part of the combustion exhaust gas into the combustion air is made possible, and thereby the flame temperature is adjustable, and thereby the emission of nitrogen oxides is counteracted.

In a further embodiment of the invention, the fan is connected, on the suction side, to an ejector having a suction connector connected to the exhaust gas line, wherein the combustion air drawn in by the fan serves as a driving medium, so that an exhaust gas/combustion air mixture is supplied to the burner by the fan. In this way, feed of a defined exhaust gas stream into the combustion air stream, with subsequent mixing by means of the fan, is achieved.

In a further development of the invention, the ejector or the exhaust gas line is provided with an adjustment device, by way of which the mixture ratio of the exhaust gas stream and the combustion air stream can be adjusted. In this way, continuous setting of the flame temperature is made possible.

In an embodiment of the invention, an optical sensor is provided, which is set up for detecting at least one flame parameter of the flame. Preferably the optical sensor is a UV sensor. Surprisingly, it has been shown that properties of the invisible flame of hydrogen combustion can be reliably determined by means of optical sensors, wherein not only the flame temperature but also other parameters can be detected by a UV sensor. It is advantageous if the optical sensor is directed at the flame base of the flame.

In a further embodiment of the invention, the UV sensor is set up for UV resonance absorption spectroscopy. In this way, detection of the NOX content of the flame and of the combustion exhaust gas surrounding it is made possible. It is advantageous if the sensor is connected to the adjustment device for setting the mixture ratio of the exhaust gas stream and the combustion air stream by way of a regulation module. In this way, temperature regulation of the flame is made possible by way of control of this mixture ratio by way of a NOX set-point setting.

In a further development of the invention, the optical sensor is connected to a setting device connected to the fuel gas supply, to interrupt and/or to adjust the hydrogen supply. In this way, escape of hydrogen in the event of extinction of the flame is counteracted.

In an embodiment of the invention, the setting device is connected to a control and regulation module, which is set up for regulating the flame properties on the basis of reference parameters stored in memory, by means of changing the hydrogen amounts and/or the combustion air amounts. Thus, for example, an optical sensor structured as a UV sensor for UV resonance absorption spectroscopy can be connected to the adjustment device for setting the mixture ratio of the exhaust gas stream and the combustion air stream, by way of the control and regulation module, and thereby temperature regulation of the flame is made possible by way of control of this mixture ratio by way of a NOX set-point setting.

Other further developments and embodiments of the invention are indicated in the remaining dependent claims. Exemplary embodiments of the invention are shown in the drawings and will be described in detail below. The figures show:

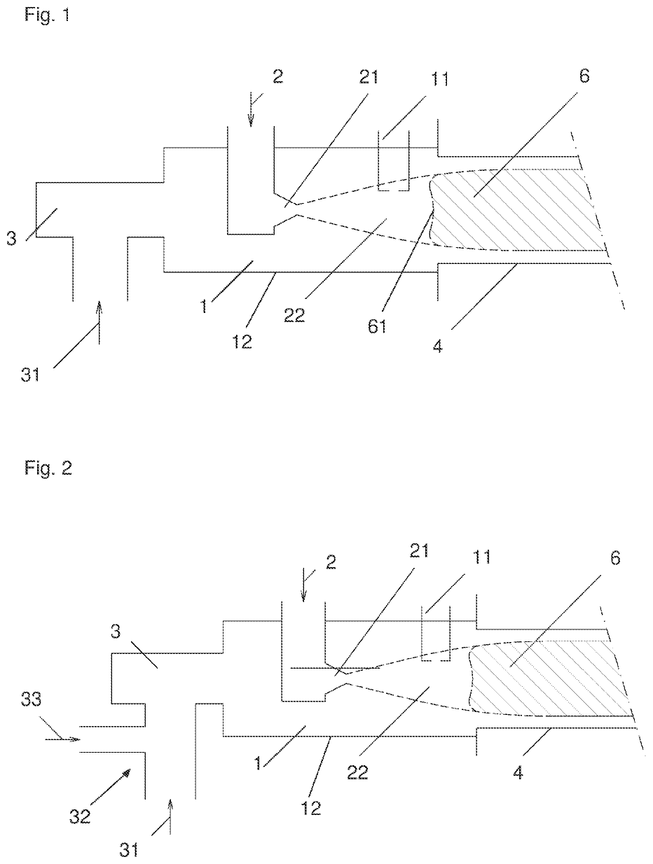

FIG. 1 the schematic representation of a dark radiator;

FIG. 2 the schematic representation of a dark radiator in a further embodiment, and

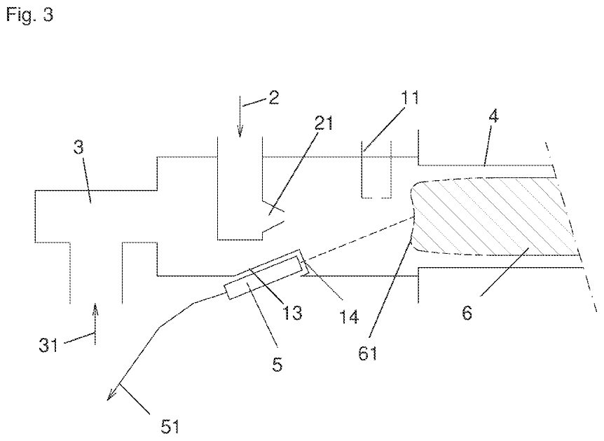

FIG. 3 the schematic representation of a dark radiator in a third embodiment.

The dark radiator according to FIG. 1, selected as an exemplary embodiment, comprises a burner 1 that is connected to a fan 3 and followed by a radiant tube 4. The radiant tube 4 is merely indicated in FIG. 1; the radiant tube 4 can certainly extend over several meters in length and be formed from multiple radiant tube elements. In the exemplary embodiment, the radiant tube 4 is formed as a highly heat-resistant stainless steel tube. Alternatively, special steels having a thermally applied aluminum oxide layer can also be used. In the exemplary embodiment, the radiant tube 4 is enclosed by a reflector—not shown—which is formed, in the exemplary embodiment, from surface-structured sheet aluminum and has bulkhead plates on both sides, to reduce convective losses.

The burner 1 comprises a gas nozzle 21 that is connected to a hydrogen supply 2. At a distance from the gas nozzle 21, an ignition electrode 11 is arranged in the burner 1. On the side of the burner 1 facing away from the ignition electrode 11, the fan 3 is set in such a manner that is flushes the gas nozzle 21 with combustion air. For this purpose, the fan is connection to a combustion air supply 31 on its suction side.

The hydrogen stream that exits from the gas nozzle 21 into the burner 1, under pressure, mixes with the combustion air stream that flushes the gas nozzle 21, and is ignited when the required mixture ratio is reached, by means of the ignition electrode 11 arranged at a distance from the gas nozzle 21, and thereby a flame 6 is formed at a distance from the gas nozzle 21, which flame extends over the length of the radiant tube 4, into the latter. In the region 22 of the hydrogen stream that is not capable of ignition, which does not have a sufficient mixture ratio with combustion air, no flame formation takes place.

In the exemplary embodiment according to FIG. 2, the fan 3 is connected, on its suction side, to an ejector 32, the drive connector of which is connected to a combustion air supply 31 and the suction connector of which is connected to an exhaust gas supply 33. The exhaust gas supply is supplied from an exhaust gas line—not shown—which is connected to the radiant tube 4 on the exhaust gas side. The combustion air drawn in by the fan 3 serves as a drive medium here, by means of which drawing in of the exhaust gas is brought about. On the pressure side, the gas nozzle 21 the gas nozzle 21 is flushed with an exhaust gas/combustion air mixture by means of the fan 3, in this way. The exhaust gas/combustion air mixture has a reduced oxygen content, and thereby a flame having a reduced temperature is brought about. Due to the great reactivity of hydrogen, even a slight oxygen content in the exhaust gas/combustion air mixture is sufficient for ignition, and thereby a flame 6 that extends through the radiant tube 4 is produced.

In the exemplary embodiment according to FIG. 3, a sensor holder 13 is introduced into the housing 12 of the burner 11, which holder has a window 14. A UV sensor 5 is introduced into the sensor holder 13, which sensor is connected, by way of an electrical line 51, with a setting device—not shown—for interrupting the hydrogen supply 2. In the exemplary embodiment, the UV sensor 5 is directed at the center of the flame base 61 of the flame 6. If no flame 6 is detected by the UV sensor 5, the hydrogen supply is interrupted by the setting device. The setting device or a control and regulation module connected to it can also be additionally connected with the ignition electrode 11 and set up in such a manner that in the event of no flame being detected, first the ignition electrode 13 is activated, and interruption of the hydrogen supply takes place only if a flame continues to be absent.

If the fan 3 according to the exemplary embodiment according to FIG. 2 is connected, on the suction side, to an ejector, by way of which mixing of an exhaust gas stream into the combustion air stream takes place, then the ejector or the exhaust gas supply line that feeds it on the suction side can be provided with an adjustment device, by way of which the mixture ratio of the exhaust gas stream and the combustion air stream can be adjusted. If the UV sensor is set up for UV resonance absorption spectroscopy, then regulation of the flame temperature on the basis of a NOX content detected by the UV sensor is possible. For this purpose, it is practical if the sensor is connected to a regulation module, the reference value of which is a predetermined reference NOX value, wherein the actual NOX value is supplied by the UV sensor. On the basis of the difference between the reference value and the actual value, an adjustment of the mixture ratio of the exhaust gas stream and the combustion air stream can take place, and thereby a change in the temperature of the flame 6 is brought about, and this in turn brings about a change in the actual NOX value.

1. A dark radiator having a burner (1), a fan (3), and a radiant tube (4), wherein the burner (1) is connected to a fuel gas supply, wherein the fan (3) is set up for supplying combustion air to the burner (1), wherein the burner (1) is set up for outputting a flame (6) into the radiant tube (4), wherein the fuel gas supply (2) is connected to a hydrogen source as the fuel gas source, and has a gas nozzle (21), wherein an ignition device (11) is arranged at a distance from the gas nozzle (21), without the presence of a flame holder.

2. The dark radiator according to claim 1, wherein the fan (3) is arranged in such a manner that the radiant tube (4) is flooded with combustion air, at least in the flame direction, behind the gas nozzle (21).

3. The dark radiator according to claim 2, wherein the fan (3) is arranged in such a manner that the gas nozzle (21) is flushed with combustion air.

4. The dark radiator according to claim 1, wherein the fan (3) is connected, on the suction side, to an exhaust gas line that is connected to the radiant tube (4).

5. The dark radiator according to claim 4, wherein the fan (3) is connected, on the suction side, to an ejector (32), having a suction connector connected to the exhaust gas line, wherein the combustion air drawn in by the fan (3) serves as a driving medium, so that an exhaust gas/combustion air mixture is supplied to the burner (1) by the fan (3).

6. The dark radiator according to claim 4, wherein the ejector (32) or the exhaust gas line is provided with an adjustment device, by way of which the mixture ratio of the exhaust gas stream and the combustion air stream can be adjusted.

7. The dark radiator according to claim 1, wherein an optical sensor is provided, which is set up for detecting at least one flame parameter of the flame (6).

8. The dark radiator according to claim 7, wherein the optical sensor is a UV sensor (5).

9. The dark radiator according to claim 7, wherein the optical sensor is directed at the flame base (61) of the flame (6).

10. The dark radiator according to claim 7, wherein the UV sensor (5) is set up for UV resonance absorption spectroscopy.

11. The dark radiator according to claim 7, wherein the optical sensor is connected to a setting device connected to the fuel gas supply, to interrupt and/or to adjust the hydrogen supply (2).

12. The dark radiator according to claim 11, wherein the setting device is connected to a control and regulation module, which is set up for regulating the flame properties of the flame (6) on the basis of reference parameters stored in memory, by means of changing the hydrogen amount and/or the combustion air amount.
